(19) United States
(12) Patent Application Publication
(10) Pub. No.: US 2016/0381076 A1
(43) Pub. Date: Dec. 29, 2016

(54) SERVICE LEVEL AGREEMENTS AND APPLICATION DEFINED SECURITY POLICIES FOR APPLICATION AND DATA SECURITY REGISTRATION

(71) Applicant: Avocado Systems Inc., San Jose, CA (US)

(72) Inventors: Keshav Govind Kamble, San Jose, CA (US); Amitabh Sinha, Fremont, CA (US)

(21) Appl. No.: 15/191,420

(22) Filed: Jun. 23, 2016

Related U.S. Application Data
(60) Provisional application No. 62/184,255, filed on Jun. 25, 2015.
(60) Provisional application No. 62/183,469, filed on Jun. 23, 2015.

(51) Int. Cl. H04L 29/06

(52) U.S. Cl. CPC H04L 63/20; H04L 63/0209; H04L 63/205

(57) ABSTRACT

According to one embodiment, a method includes determining one or more communication requirements for an application or application instance operating on a server in a network using an ADPL. The method also includes providing, by the ADPL, one or more communication and security policies to at least one security appliance in the network based on the one or more communication requirements of the application or application instance. The method may also include registering, by the ADPL, a new application or application instance and sending details of the new application or application instance to a policy orchestrator. Moreover, the method may include receiving, by the ADPL from the policy orchestrator, feedback pursuant to a service level agreement for an application group to which the new application or application instance belongs.

### FIELD OF THE INVENTION

The present invention relates to network and system protection, and more particularly, this invention relates to service level agreements and application defined security policies as they are used in application and data security and security registration.

### BACKGROUND

Applications are made up of a large number of instructions and data. Instructions operate on data which is fetched in a cache and memory and is always unencrypted. Scaled-out, distributed applications are made up of a large number of application instances. These application instances have their own data in the cache and memory of the processor on which these applications run. A large number of such application instances communicate with each other and process data in parallel to create an aggregate output.

With thousands or even millions of applications and application instances running on a large number of servers, it is difficult to determine the health of an individual application or application instance and the security details of the individual application or application instance. Especially in virtualized data centers, applications are moved with the virtual machine (VM) or with a container. Tracking applications in such large data centers with virtualized workloads becomes yet another challenge. Moreover, security and behavior of the application become difficult tasks to maintain.

Scaled-out, distributed applications work as large numbers of application instances which may be spread across a data center. Each instance of the application processes different data sets in parallel. Due to virtualization and allocation of resources dynamically across the data center, tracing each instance of the application is incredibly useful for management of the data center, if not necessary.

Also, these types of scaled-out applications are extremely vulnerable to application breaches, data thefts from cache and memory by scraping, and other methods of illicitly obtaining data from the applications, cache, and/or memory. In data centers which cater to important applications and data types, such as Personally Identifiable Information (PII), Payment Card Industry (PCI) data, medical information that falls under Health Insurance Portability and Accountability Act (HIPAA), military and Government critical tasks, any application and/or data breach is very destructive and expensive to contain and/or resolve. Therefore, it is beneficial to attempt to prevent such breaches and protect applications and data from malware attacks.

Also, applications and application instances lack the capability to protect themselves from malware attacks propagated from outside the network or data center. Various flows created by the applications and application instances may be considered for application behavior analysis; however, the analysis is not performed 100% of the time, since complex application behavior is not understood by administrators who are tasked with management of the applications. The application behavior is attempted to be predicted by people who have little to no experience in the writing and architecture of the applications. Therefore, security policies based on this understanding of the application behavior is incomplete and lacking in protection.

### SUMMARY

In one embodiment, a system includes a processing circuit and logic integrated with and/or executable by the processing circuit. The logic is configured to cause the processing circuit to determine one or more communication requirements for an application or application instance operating on a server in a network using an application and data protection layer (ADPL). The logic is also configured to cause the processing circuit to provide, by the ADPL, one or more communication and security policies to at least one security appliance in the network based on the one or more communication requirements of the application or application instance.

According to another embodiment, a method includes determining one or more communication requirements for an application or application instance operating on a server in a network using an ADPL. The method also includes providing, by the ADPL, one or more communication and security policies to at least one security appliance in the network based on the one or more communication requirements of the application or application instance.

In yet another embodiment, a computer program product includes a computer readable storage medium having program instructions stored thereon. The program instructions are executable by a processing circuit to cause the processing circuit to determine one or more communication requirements for an application or application instance operating on a server in a network using an ADPL. The program instructions also cause the processing circuit to provide, by the ADPL, one or more communication and security policies to at least one security appliance in the network based on the one or more communication requirements of the application or application instance.

The embodiments described above may be implemented in any computing system environment known in the art, such as a networking environment, which may include a processor and a computer readable storage medium configured to store data and logic, the logic being implemented with and/or executable by the processor to cause the processor to perform one or more functions.

### BRIEF DESCRIPTION OF THE DRAWINGS

The following descriptions of the drawings are not meant to be limiting on what is taught by the drawings in any manner. For a fuller understanding of the content of each drawing, the following brief descriptions are provided, which when read in conjunction with the detailed description, describe the full breadth of the various embodiments of the present invention.

FIG. 1 shows a network architecture, according to one embodiment.

FIG. 2 shows a hardware environment that may be associated with the network architecture of FIG. 1, according to one embodiment.

FIG. 3 shows a logical representation of an application instance operating on a computing system, in accordance with one embodiment.

FIG. 4 shows an application and data protection library (ADPL) control model implemented in a data center, according to one embodiment.

FIG. 5 shows a flowchart of a method, according to one embodiment.

FIG. 6 shows a flowchart of a method, according to one embodiment.

### DETAILED DESCRIPTION

The descriptions presented herein are intended to enable any person skilled in the art to make and use the present invention and are provided in the context and requirements of particular applications of the present invention.

Unless otherwise specifically defined herein, all terms are to be given their broadest possible interpretation including meanings implied from the specification as well as meanings understood by those skilled in the art and/or as defined in dictionaries, treatises, etc. It must also be noted that, as used in the specification and the appended claims, the singular forms “a,” “an,” and “the” include plural referents unless otherwise specified.

Moreover, the term “about” when used herein to modify a value indicates a range that includes the value and less and greater than the value within a reasonable range. In the absence of any other indication, this reasonable range is plus and minus 10% of the value. For example, “about 10 milliseconds” indicates 10 ms±1 ms, such that the range includes all values in a range including 9 ms up to and including 11 ms.

Also, the term “comprise” indicates an inclusive list of those elements specifically described without exclusion of any other elements. For example, “a list comprises red and green” indicates that the list includes, but is not limited to, red and green. Therefore, the list may also include other colors not specifically described.

Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown and described herein, but is to be accorded the widest scope consistent with the principles and features disclosed herein.

In particular, various embodiments of the invention discussed herein may be implemented using a network, such as the Internet, to communicate among a plurality of computer systems. One skilled in the art will recognize that the present invention is not limited to the use of the Internet as a communication medium and that alternative methods of the invention may accommodate the use of a private intranet, a Local Area Network (LAN), a Wide Area Network (WAN), or other communication media. In addition, various combinations of wired (e.g., Ethernet), wireless (e.g., radio frequency) and optical communication links (e.g., fiber optic) may be utilized.

The term application as used herein refers to any type of software and/or hardware-based application, such as enterprise data center applications, Internet-of-Things (IOT) applications, Industrial control applications, military applications, etc.

Enterprise data center applications may include any of the following application types: financial applications, equity trading applications, healthcare applications, financial transaction applications, etc.

IOT applications may include any of the following application types: mobile communication applications, home automation/control applications, industrial automation/control applications, security and monitoring applications, etc.

Industrial control applications may include any of the following application types: nuclear power plant control, thermal power plant control, hydro-electric power plant control, wind farm control, electricity grid and distribution control, water treatment control, land-based traffic control, air traffic control, etc.

Military applications may include any of the following application types: military installation control, first alert system control, autoguided weapon system control, military weaponized equipment control including manned vehicles, weaponized and/or surveillance-oriented unmanned vehicle control (drones) such as unmanned aerial vehicles (UAVs), unmanned aircraft systems (UASs), unmanned underwater vehicles (UUVs), unmanned ground vehicles (UGVs), etc.

A program environment in which one embodiment may be executed illustratively incorporates one or more general-purpose computers and/or special-purpose devices, such as switches, routers, switch controllers, etc. Details of such devices (e.g., processor, memory, data storage, input devices, and output devices) are well known and are omitted for the sake of clarity.

It should also be understood that the techniques of the present invention may be implemented using a variety of technologies. For example, the methods described herein may be implemented in software running on a computer system, implemented in hardware utilizing one or more hardware processors and logic (hardware logic and/or software logic) implemented with and/or executable by the hardware processor. The logic is configured to cause the processor to perform operations of a method, and may take any form known to those of skill in the art, such as application specific integrated circuits (ASICs), programmable logic devices such as Field Programmable Gate Arrays (FPGAs), and/or various combinations thereof.

In one illustrative approach, methods described herein may be implemented by a series of computer-executable instructions stored to a computer readable storage medium, such as a physical (e.g., non-transitory) data storage medium. In addition, although specific embodiments may employ object-oriented software programming concepts, the present invention is not so limited and is adaptable to employ other forms of directing the operation of a processor.

The present invention may also be provided in the form of a computer program product comprising a computer readable storage medium having program instructions thereon or a computer readable signal medium having program instructions therein, which may be executed by a computing device (e.g., a processor) and/or a system. A computer readable storage medium may include any medium capable of storing program instructions thereon for use by a computing device or system, including optical media such as read only and writeable CDs and DVDs, magnetic memory or media (e.g., hard disk drive, magnetic tape, etc.), semiconductor memory (e.g., FLASH memory, non-volatile random access memory (NVRAM), and other non-volatile storage media known in the art), firmware encoded in a microprocessor, etc.

A computer readable signal medium is one that does not fit within the aforementioned computer readable storage medium definitions. For example, illustrative computer readable signal media communicate or otherwise transfer transitory signals within a system, between systems, etc., e.g., via a physical or virtual network having a plurality of connections.

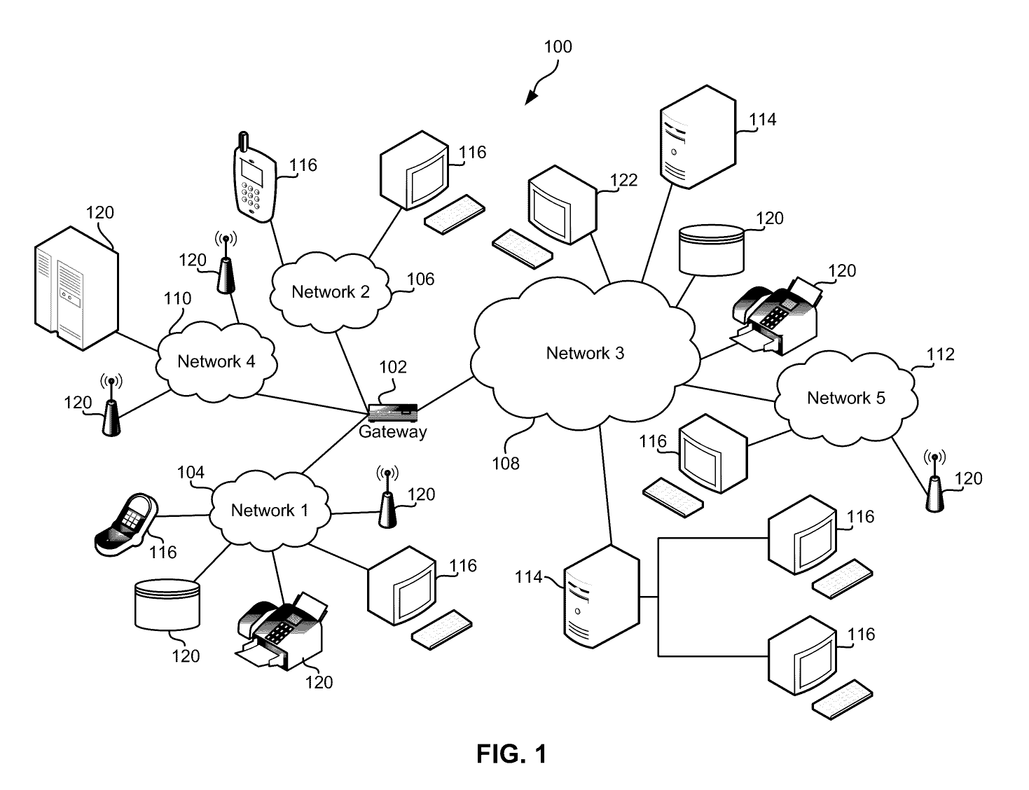

FIG. 1 illustrates an architecture 100, in accordance with one embodiment. As an option, the present architecture 100 may be implemented in conjunction with features from any other embodiment listed herein, such as those described with reference to the other figures. Of course, however, such architecture 100 and others presented herein may be used in various applications and/or in permutations which may or may not be specifically described in the illustrative embodiments listed herein. Further, the architecture 100 presented herein may be used in any desired environment.

As shown in FIG. 1, a plurality of remote networks are provided including a first remote network 104 and a second remote network 106. A gateway 102 may be coupled between the remote networks 104, 106 and a proximate network 108. In the context of the present network architecture 100, the networks 104, 106 may each take any form including, but not limited to, a LAN, a WAN such as the Internet, a storage area network (SAN), a public switched telephone network (PSTN), an internal telephone network, etc. Additional networks 110, 112 may also be connected via the gateway 102 or some other connection device known in the art. These networks may be of a different type than the networks 104, 106. For example, network 110 may be a network devoted to the IOT, and may provide infrastructure and protocols for communication between all devices in the IOT, and between any devices in the IOT and the networks 104, 106. In another example, network 112 may be a network devoted to Industrial control, and may provide infrastructure and protocols for communication within and/or between facilities anywhere in the world, including automated devices, manufacturing lines, assembly lines, processing control software, etc.

In use, the gateway 102 serves as an entrance point from the remote networks 104, 106 to the proximate network 108. As such, the gateway 102 may function as a router, which is capable of directing a given packet of data that arrives at the gateway 102, and a switch, which furnishes the actual path in and out of the gateway 102 for a given packet.

Further included in the network architecture 100 is at least one data server 114 coupled to the proximate network 108, and which is accessible from the remote networks 104, 106 via the gateway 102. It should be noted that the data server(s) 114 may include any type of computing device/groupware. Coupled to each data server 114 is a plurality of user devices 116. User devices 116 may include any device known by those of skill in the art, such as a desktop computer, a laptop computer, a hand-held computer, a smartphone, a terminal, a port, a printer, some type or form of logic, etc. It should be noted that a user device 122 may also be directly coupled to any of the networks, in one embodiment.

A peripheral 120 or series of peripherals 120, e.g., facsimile machines, printers, networked storage units, hard disk drives, wireless routers, etc., may be coupled to one or more of the networks 104, 106, 108, 110, 112. It should be noted that databases, servers, mainframes, and/or additional components may be utilized with and/or integrated into any type of network element coupled to the networks 104, 106, 108, 110, 112. In the context of the present descriptions, a network element may refer to any component of a network, system, device, and/or any device useable in a network.

According to some approaches, methods and systems described herein may be implemented with and/or utilized on virtual systems and/or systems which emulate one or more other systems, such as a UNIX system which emulates a MAC OS environment, a UNIX system which virtually hosts a MICROSOFT WINDOWS environment, a MICROSOFT WINDOWS system which emulates a MAC OS environment, etc. This virtualization and/or emulation may be enhanced through the use of virtualization software, such as VMWARE ESX, MICROSOFT HYPER-V, SIMICS, etc., in some embodiments.

In more approaches, one or more of the networks 104, 106, 108, 110, 112 may represent a cluster of systems commonly referred to as a “cloud.” In cloud computing, shared resources, such as processing power, peripherals, software, data processing, servers, storage, etc., are provided to any system that has access to the cloud and permission to access the specific resource, preferably in an on-demand relationship, thereby allowing access and distribution of services across many computing systems. Cloud computing typically involves an Internet or other high speed connection (e.g., 4G LTE, fiber optic, etc.) between the systems operating in the cloud, but other techniques of connecting the systems may also be used as would be understood by those of skill in the art.

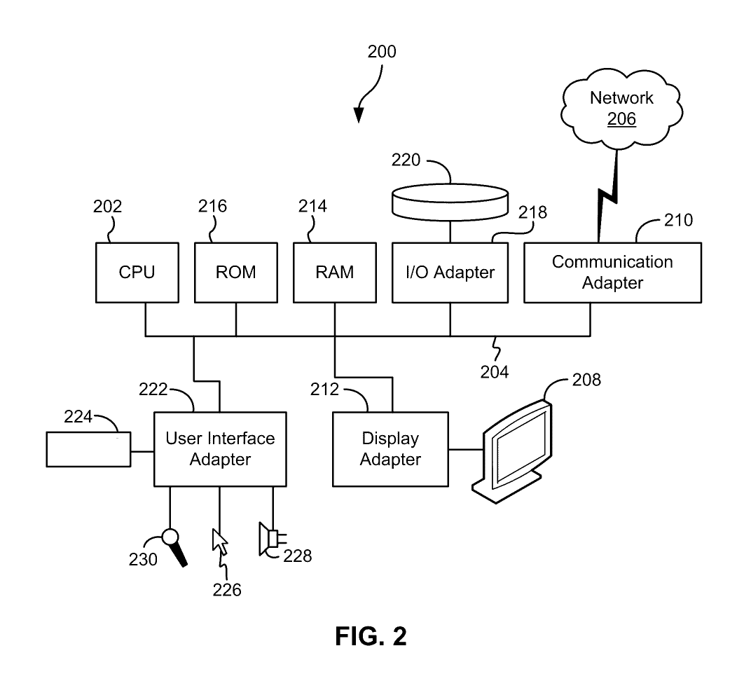

FIG. 2 shows a representative hardware environment associated with a user device 116 and/or a server 114 of FIG. 1, in accordance with one embodiment. FIG. 2 illustrates a typical hardware configuration of a workstation 200 having a central processing unit 202, such as a microprocessor, and a number of other units interconnected via a system bus 204.

The workstation 200 shown in FIG. 2 includes a Random Access Memory (RAM) 214, Read Only Memory (ROM) 216, an I/O adapter 218 configured to connect peripheral devices, such as disk storage units 220 to the bus 204, a user interface adapter 222 configured to connect a keyboard 224, a mouse 226, a speaker 228, a microphone 230, and/or other user interface devices such as a touch screen, a digital camera, etc., (not shown) to the bus 204, communication adapter 210 configured to connect the workstation 200 to a communication network 206 (e.g., a data processing network) and a display adapter 212 configured to connect the bus 204 to a display device 208.

The workstation 200 may have resident thereon an operating system, such as the MICROSOFT WINDOWS Operating System (OS), a MAC OS, a UNIX OS, etc. It will be appreciated that a preferred embodiment may also be implemented on platforms and operating systems other than those specifically mentioned herein. A preferred embodiment may be written using JAVA, XML, C, and/or C++ language, SCALA, COBOL, FORTRAN, or other programming languages, along with an object oriented programming methodology or scripting language such as PERL, PYTHON, Tcl/Tk, or other scripting languages. Object oriented programming (OOP), which has become increasingly used to develop complex applications, may also be used.

Moreover, one or more hardware processors may be implemented in a processing circuit in the workstation 200. The processing circuit includes the one or more hardware processors, along with any connections or links therebetween necessary to interconnect the one or more processors in the processing circuit. In addition, the processing circuit may be implemented with logic and/or may be configured to execute logic, with the logic being configured to cause the processing circuit to perform functionality specified by the logic.

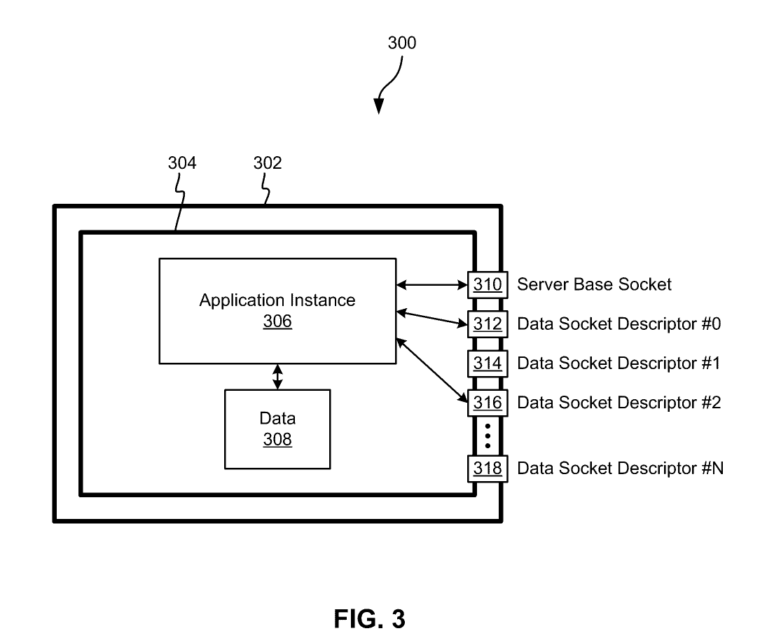

Now referring to FIG. 3, a logical representation of an application instance 306 operating on a computing system 300 is shown according to one embodiment. Although only one application instance 306 and one set of data 308 is shown in FIG. 3, as would be understood by one of skill in the art, any number of application instances and groups of data may be hosted on a computing system 300, limited only by the processing power and/or other resources available to the computing system 300.

As shown in FIG. 3, an application protection layer (APL) 302 and a data protection layer (DPL) 304 are represented within the computing system 300, according to one embodiment. The application instance 306 has access to data 308 within the computing system 300. Also, the application instance 306, through any number of standard and/or custom application programming interfaces (APIs), may utilize any of a plurality of data socket descriptors (e.g., data socket descriptor #0 312, data socket descriptor #1 314, data socket descriptor #2 316, . . . , data socket descriptor #N 318) with which to communicate (send and/or receive) information outside of the application instance 306 or computing system 300. One or more server base sockets 310 is provided in the application instance 306 of computing system 300 and is used for control of the peer application instances on the computing system 300, outside the system, or outside the application instance 306 itself, as would be understood by one of skill in the art.

In order to provide application and data protection to application instances of distributed, scaled-out applications which have instances operating on a plurality of computing systems, at least two operations may be performed, and are described below according to one embodiment.

In a first operation, application instances, such as application instance 306, are identified based upon data socket descriptor attributes that an application instance uses to communicate between other application instances and/or group(s) of application instances on/or outside of the computing system 300. For example, in response to application instance 306 utilizing data socket descriptor #0 312 consistently to communicate with another system, an association may be established between data socket descriptor #0 312 and the application instance 306. By consistently, what is meant is that application instance 306 utilizes data socket descriptor #0 312 to communicate with another system more than a predetermined number of times within a given period of time, according to one embodiment. In another embodiment, consistently utilizing a data socket descriptor means that only a specific data socket descriptor is used in exclusion of all others over a given period of time.

In a second operation, a group is formed which includes any application instance which has all of the same socket descriptor attributes (or at least a predetermined amount of the same socket descriptor attributes, or the same of a certain group of socket descriptor attributes), e.g., data exchange sockets of the same application base socket, transport protocol, server port, various multi-tenancy characteristics, storage characteristics, payload sizes, container attributes, and/or multiple time contexts are grouped together.

Any socket descriptor attributes may be considered when determining whether an application instance shares data socket descriptor attributes with another application instance, such as OS and container attributes which include server port, transport protocol, network address translation (NAT) IP address range, maximum transmission unit (MTU), application payload sizes, user programmable attributes such as multi-tenancy labels etc.

Using the above two operations, two layers of protection (application protection and data protection) are enacted together to protect the application (not shown) from which the application instance 306 is provided and any group of application instances related to the application that provides the application instance 306.

The APL 302 works with data socket APIs and data socket libraries to provide protection to application instances and to the data that is used by the application instances. While doing so, the APL 302 does not interfere with the application architecture and its normal behavior. Though these new APIs, each application instance receives extra capabilities to ensure that all flows entering and exiting the application instance are trusted flows. Moreover, the APL 302 receives additional infrastructural help by being informed about the security status of virtual and/or physical servers on which the application instance is running, along with the security status of other application instances and their virtual and/or physical servers. Based on the comprehensive status of the servers and network in the data center, the APIs provide feedback and suggest use of data protection mechanisms to protect data in memory and cache.

FIG. 3 shows the Application and Data Protection Layer (ADPL) libraries which keep track of the server base socket 310 and various data socket descriptors 312, 314, 316, . . . , 318 opened by an application instance 306 for communication of data with one or more peer applications outside of the computing system 300. The data socket descriptors 312, 314, 316, . . . , 318 are used for the exchange of data with another system outside of the computing system 300.

The data socket descriptors 312, 314, 316, . . . , 318 are numbers that represent attributes and/or characteristics of different data exchanges between the application instance and one or more receiver hosts. Each data socket descriptors 312, 314, 316, . . . , 318 may have a size ranging from 12 to 48 bits, such as 32 bits in one embodiment.

Each of the APL 302 and the DPL 304 utilize individual sets of APIs that are configured to piggyback on existing APIs, but add specialized functionality to any action performed using the existing APIs.

These new socket APIs and data protection APIs, and the type of application payload sent and received, do not disturb the intermediate security appliances such as firewall, Intrusion Prevention and Intrusion Detection, etc.

There may be two types of APIs which are utilized by the ADPL, in addition to other APIs utilized which are not specifically discussed herein. A first type of API are security infrastructure APIs which enable applications and application instances to inform the APL 302 about any communication requests and/or anticipated communications before actually starting the anticipated/requested communications. These security infrastructure APIs also provide security policies that are applied to these communications. Moreover, these security infrastructure APIs may have any format recognized by the security policies for offloading information. The policy format and fields are not limited to standard formats, e.g., IPv4, IPv6, TCP/UDP tuples, etc.

A second type of API used by the ADPL are feedback APIs which provide security profile feedback regarding peer application(s) and/or peer application instance(s) to the application instance 306 for which the feedback APIs are called.

With the help of these APIs, the application instance 306 not only provides communication policies to the APL 302 but is also configured, in one embodiment, to provide communication policies to security appliances in the network or data center, such as firewall(s), Intrusion Detection System(s) (IDS), Intrusion Prevention System(s) (IPS), behavior analysis appliances or engines, sandboxes, etc.

The application instance 306 may also, in a further embodiment, inform one or more security appliances to remove existing policies. By following this procedure, the one or more security appliances are not confused in response to the application instance 306 generating one or more new flows. Moreover, any behavior analysis engines installed in the network or data center do not waste time trying to understand the one or more new flows and the relationship between old flow(s) and the one or more new flows.

The application instance 306 utilizes the one or more server base socket(s) 310 with standard and/or private well-known port number(s) as a control socket, but opens a new data socket descriptor and allocates a different port number to the new data socket descriptor in order to handle actual functionality and data transfer between the computing system 300 and any other external or peer system. The server base socket 310 has the following attributes and/or characteristics:
1. A server and/or a source internet protocol (IP) interface.
2. A standard and/or known server port number, e.g., transmission control protocol (TCP) port, user datagram protocol (UDP) port, etc.
3. A maximum number of allowable waiting connections.
4. A maximum (and possibly minimum) application packet buffer size usable for transmitting and receiving data.
5. Other socket options provided by the operating system, the user, or an external input.

The above described attributes and/or characteristics may also be attributed to the plurality of allocated data socket descriptors 312, 314, 316, . . . , 318. When a connection is established between the computing system 300 and another system via the application instance 306, a data socket descriptor is allocated. The allocated data socket descriptor has the following attributes and/or characteristics:
1. A server and/or a source IP interface.
2. A standard and/or known server port number, e.g., transmission control protocol (TCP) port, user datagram protocol (UDP) port, etc.
3. A maximum number of allowable waiting connections.
4. Application packet buffer size for transmit and receive.
5. A port number of the transport of the allocated data socket descriptor (in the computing system 300).
6. An IP address of the peer data socket descriptor (in an external system) of the allocated data socket descriptor (usually, but not always, in TCP sockets).
7. A port number of the transport of the peer data socket descriptor of the allocated data socket descriptor in all cases of controlled port allocations by the application instance 306.
8. A maximum (and possibly minimum) application packet buffer size usable for transmitting data to and receiving data from (transmissions with) the peer data socket descriptor.

Apart from the above described characteristics and/or attributes, additional characteristics that may be attributable to an allocated data socket descriptor include:
9. A first identifier (ID1): a globally unique identification number given for an entity (such as an enterprise, company, university, city subdivision, etc.) that utilizes the ADPL mechanism in the application instances or programmed for proprietary purposes.
10. A second ID (ID2): a unique identification number within the entity (not necessarily globally unique). Each ID2 represents a subdivision within the entity, such as an individual business unit within an enterprise, a water district within a city, etc., or programmed for proprietary purposes.
11. Secure base signature: a base signature or scrambled alphanumeric or numerical code used in the generation of signatures per data socket descriptor.
12. Secure runtime signature: a scrambled alphanumeric or numerical code used as a signature on a per data socket descriptor basis.
13. Application name: a name given to the application instance operating on the computing system.
14. Application ID: an identification number provided to the application instance operating on the computing system.
15. Process ID: an identification number provided to a particular process which is accountable for the data.
16. Server port: the particular port on the server on which data is received or sent.
17. Transport protocol: the particular transport protocol used to send data.
18. Base Crypto Version: the version of the cryptographic process used to encrypt data.
19. Co-Lo Need: Co-locationing criterions where applications or application instances may reside together in the same server, server pool, rack, pod, or data center.
20. Architecture Tier: a tier within the system architecture on which the (web, application, database, etc.) operates.
21. Storage Attachments: an attribute that describes how the storage is attached to the computing system (e.g., direct, network, distributed, etc.)
22. Proprietary Multi-Tenant Label: a label within the ADPL tag which designates some information selectable by the user.

These unique attributes when combined together in one of many different variations, are able to identify a data socket descriptor, and locks that data socket descriptor to one particular instance of a scaled-out application group.

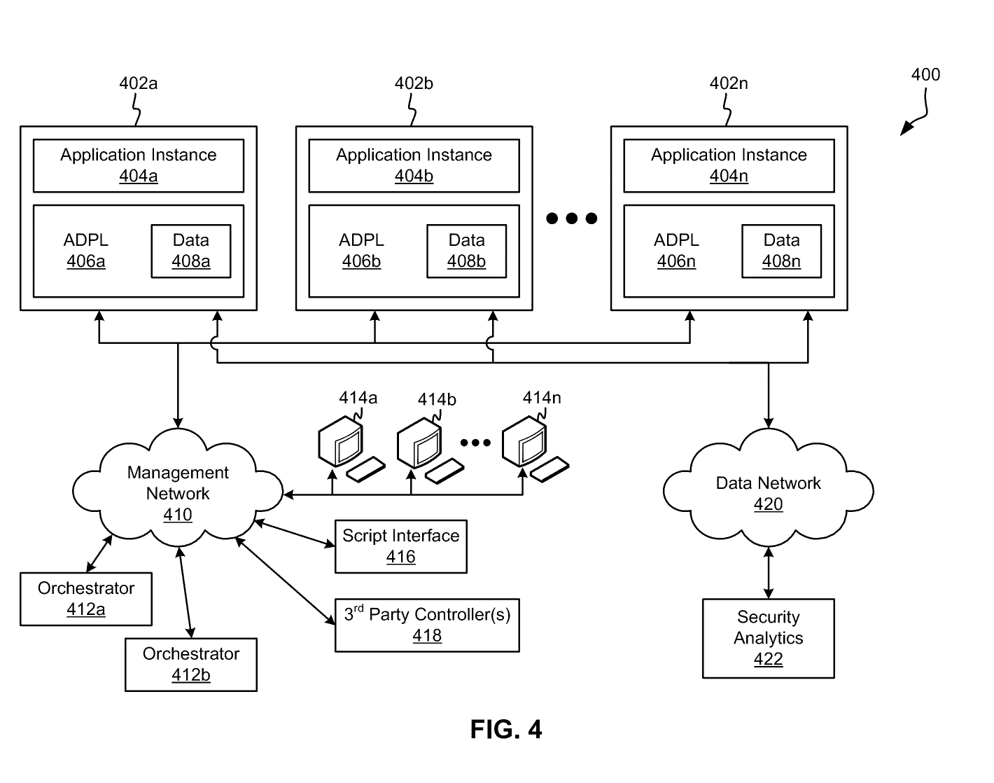

FIG. 4 shows the ADPL control model implemented in a data center 400, according to one embodiment. As shown, one or more policy orchestrators 412a, 412b is associated with the management network 410. More than one policy orchestrator may be utilized in high availability (HA) mode. Each policy orchestrator 412a, 412b may include segment management, policies management, configuration management, application tracking, a security trending controller, and software defined control.

From the management network 410, APIs, such as representational state transfer (REST) APIs (among others known in the art), may be distributed to the plurality of management consoles 414a, 414b, . . . , 414n, the scripted interface 416, and/or to one or more third party controllers 418. Each of the plurality of management consoles 414a, 414b, . . . , 414n may include a graphical interface, REST API-based programmability, trending, analysis, auditing, and third party controller integration.

One or more virtual platforms 402a, 402b, . . . , 402n host one or more ADPL-shielded application instances 404a, 404b, . . . , 404n along with data 408a, 408b, . . . , 408n utilized by each application instance 404a, 404b, . . . , 404n which are protected by ADPLs 406a, 406b, . . . , 406n.

The primary policy orchestrator 412a communicates to the one or more ADPL-shielded application instances 404a, 404b, . . . , 404n through the management network 410. Each of the ADPLs 406a, 406b, . . . , 406n operating for each individual application instance 404a, 404b, . . . , 404n may include application protection and policy enforcement, data protection and policy enforcement, and collection of statistics of normal and malicious behavior.

The data network 420 is associated with a security analytics module 422 which may include a security analytics engine and a collection of security analysis tools. In more approaches, the security analytics module 422 may include FireEye Sandbox, and/or other third party security analysis tools, from third parties such as IBM, CISCO, SYMANTEC, MCAFEE, etc. Moreover, the security analytics module 422 may provide feedback to the one or more policy orchestrators 412a, 412b.

One or more of the application instances 404a, 404b, . . . , 404n may be grouped together in pico-segments or groups that each include related application instances that share characteristics based on data socket descriptors, among other characteristics. The policy orchestrator 412a, 412b interacts with the various pico-segments of application instances in which ADPL-shielded application instances 404a, 404b, . . . , 404n are grouped together as a whole, rather than with each individual application instance individually.

Each application instance 404a, 404b, . . . , 404n is aware of itself and understands its own behavior and various flows that are used by the application instance for its proper functioning. Application architects and programmers may provide intelligence to the application instances 404a, 404b, . . . , 404n by using special APIs to provide policy offloads as indicated by demands of the application instances 404a, 404b, . . . , 404n. Providing this capability to the various application instances 404a, 404b, . . . , 404n through standard APIs solves problems associated with conventional security policy practices and introduces deterministic behavior to application and data security.

With this new approach that allows the application instances 404a, 404b, . . . , 404n to protect themselves and their data 4048a, 408b, . . . , 408n from malware attacks, more malware attacks may be inhibited and/or defeated before crucial data is compromised. This new approach utilizes socket APIs and/or libraries to provide protection to application instances 404a, 404b, . . . , 404n and associated data 408a, 408b, . . . , 408n. Moreover, this new approach does not interfere with the application architecture and normal operation and behavior thereof.

According to one embodiment, an application administrator or some other authorized user or automated routine may choose individual applications or application instances to utilize ADPL for protection. In an alternate embodiment, all applications and instances thereof may utilize ADPL on servers that are configured to run ADPL. However, when only a select number of applications or application instances utilize ADPL for protection, the selection process and outcome (selected applications and instances) are provided to the policy orchestrator or some other authorized controller in the network in the form of a configuration file which encapsulates details of a service level agreement (SLA). The configuration file includes a plurality of detail fields that describe the application or instance including, but not limited to, the following fields: application name, application directory path on the target server, hash value (such as MD5 sum) of the application executable file, application vendor name, application user enterprise name (ID1), application user department name (ID2), license key issued by the ADPL vendor, date of license issue, scalability parameters and/or requirements (that may be specific to individual features of the application or instance, or general to the entire application or instance), etc.

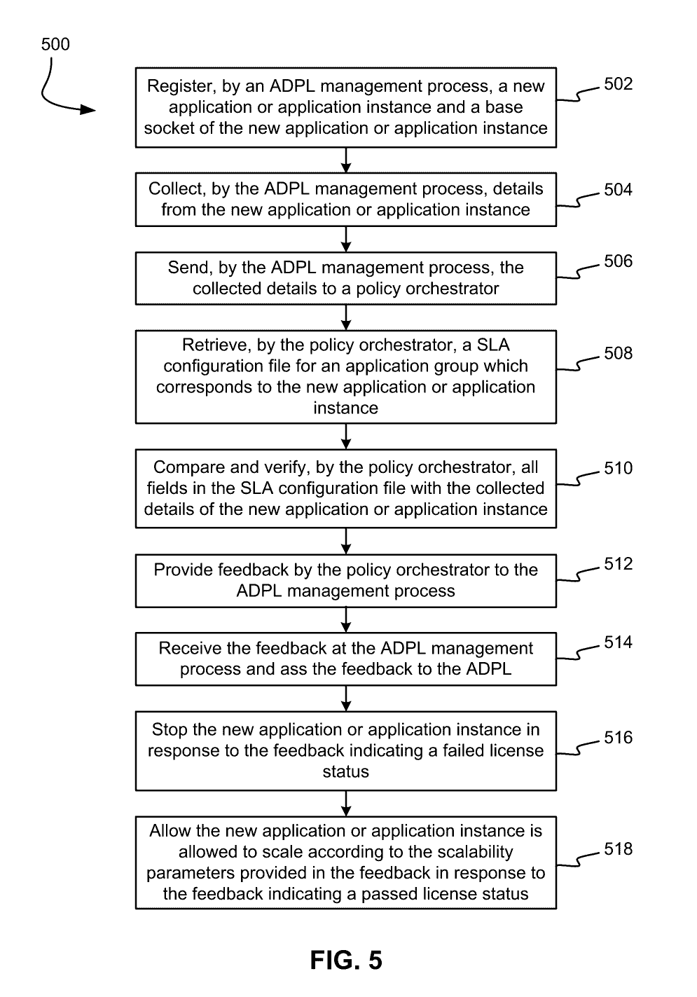

Now referring to FIG. 5, a flowchart of a method 500 is shown according to one embodiment. The method 500 may be performed in accordance with the present invention in any of the environments depicted in FIGS. 1-4, among others, in various embodiments. Of course, more or less operations than those specifically described in FIG. 5 may be included in method 500, as would be apparent to one of skill in the art upon reading the present descriptions.

Each of the steps of the method 500 may be performed by any suitable component of the operating environment. For example, in various embodiments, the method 500 may be partially or entirely performed by a server, host, computing system, processor, switch, or some other device having one or more processing units therein. The processing unit, e.g., processing circuit(s), chip(s), and/or module(s) implemented in hardware and/or software, and preferably having at least one hardware component, may be utilized in any device to perform one or more steps of the method 500. Illustrative processing units include, but are not limited to, a central processing unit (CPU), an ASIC, a FPGA, etc., combinations thereof, or any other suitable computing device known in the art.

As shown in FIG. 5, method 500 may initiate with operation 502, where a management process of the ADPL is called or is started in response to discovery of a new application or application instance. The ADPL management process registers the new application or application instance, a base socket of the new application or application instance, and other details of the new application or application instance (such as those described previously).

In operation 504, the ADPL management process collects details from the new application or application instance. These details may include any of those described above that are included in the SLA configuration file.

In operation 506, the ADPL management process sends the collected details to a policy orchestrator or some other central controller configured to dictate policy adherence in the network.

In operation 508, the policy orchestrator retrieves a SLA configuration file for an application group which corresponds to the new application or application instance (e.g., the new application or application instance belongs to the application group due to shared characteristics).

In operation 510, the policy orchestrator compares all fields in the SLA configuration file with the collected details of the new application or application instance. When all fields match, the SLA is verified for the new application or application instance and a passed license status is indicated; otherwise, a failed license status is indicated.

In operation 512, the policy orchestrator provides feedback regarding the license status (passed/failed), scalability parameters (indicating an allowed number of instances for the application or for individual features of the application), along with any other application-specific parameters that allow for functionality of the application to be realized. This feedback is provided to the ADPL management process in one embodiment.

In operation 514, the ADPL management process receives the feedback from the policy orchestrator and passes the feedback (as received or in a modified form) to the ADPL

In operation 516, in response to the feedback indicating a failed license status, the new application or application instance is stopped or otherwise caused to cease operation. In one embodiment, all functioning APIs related to the new application or application instance are caused to return a failure, and the application ceases communications with any other application, device, system, etc.

In operation 518, in response to the feedback indicating a passed license status, the new application or application instance is allowed to scale (number of instances operating, features allowed, features used in parallel, etc.) according to the scalability parameters provided in the feedback. Moreover, the ADPL begins protecting the new application or application instance and all data associated therewith on the server.

Method 500 may be implemented as a system, process, or a computer program product. As a system, method 500 may be implemented on the first host and/or the second host as logic configured to perform method 500, along with being implemented on any other hosts on which secure communications are desired. As a computer program product, a computer readable storage medium may store program instructions configured to perform method 500.

For example, a system may include a processing circuit and logic integrated with and/or executable by the processing circuit. The processing circuit is a non-transitory hardware device configured to execute logic embedded therein, or provided thereto. Examples of processing circuits include, but are not limited to, CPUs, ASICs, FPGAs, microprocessors, integrated circuits, etc. The logic is configured to cause the processing circuit to perform method 500, in one embodiment.

In another example, a computer program product may include a computer readable storage medium having program instructions stored thereon. The computer readable storage medium is a non-transitory device configured to store program instructions that are executable and/or readable by a processing circuit. The program instructions are executable by a processing circuit to cause the processing circuit to perform method 500 in one embodiment.

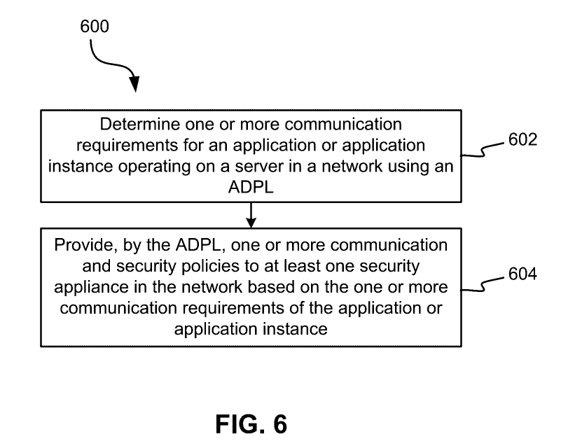

Now referring to FIG. 6, a flowchart of a method 600 is shown according to one embodiment. The method 600 may be performed in accordance with the present invention in any of the environments depicted in FIGS. 1-4, among others, in various embodiments. Of course, more or less operations than those specifically described in FIG. 6 may be included in method 600, as would be apparent to one of skill in the art upon reading the present descriptions.

Each of the steps of the method 600 may be performed by any suitable component of the operating environment. For example, in various embodiments, the method 600 may be partially or entirely performed by a server, host, computing system, processor, switch, or some other device having one or more processing units therein. The processing unit, e.g., processing circuit(s), chip(s), and/or module(s) implemented in hardware and/or software, and preferably having at least one hardware component, may be utilized in any device to perform one or more steps of the method 600. Illustrative processing units include, but are not limited to, a CPU, an ASIC, a FPGA, etc., combinations thereof, or any other suitable computing device known in the art.

As shown in FIG. 6, method 600 may initiate with operation 602, where one or more communication requirements for an application or application instance operating on a server in a network are determined using an ADPL. The communication requirements may include any indications of data transfers between the application or application instance operating on the server and any other application, instance, server, host, or device in the network or outside of the network.

In operation 604, one or more communication and security policies are provided to at least one security appliance in the network based on the one or more communication requirements of the application or application instance. The one or more communication and security policies dictate actions to be taken based on security profiles received by the ADPL. For example, the policies may dictate to drop a packet, drop-and-analyze, allow the packet, allow-and-analyze, etc.

According to one embodiment, the one or more communication and security policies may be provided, sent, or otherwise given to the at least one security appliance via one or more APIs. Moreover, the at least one security appliance may be of any type known in the art, such as a firewall, an intrusion detection system (IDS), an intrusion protection system (IDS), etc.

According to another embodiment, the one or more communication requirements may be determined via one or more APIs. In this embodiment, method 600 may further include determining which communication and security policies to provide to the at least one security appliance and which communication and security policies to enforce using the ADPL based on the one or more communication requirements for the application or application instance. This decision may be based on history of the application's operation, default settings, security profile exchange, or some other policy or method which results in the efficient and effective protection of the application or application instance.

In another embodiment, method 600 may include determining which communication and security policies to remove from the at least one security appliance and which communication and security policies to stop enforcing using the ADPL based on the one or more communication requirements for the application or application instance. This determination may be based on reducing overhead for the application and/or network, removing policies which no longer apply to applications and application instances currently operating on the server, or some other reasonable decision as would be understood by those of skill in the art upon reading the present descriptions.

According to yet another embodiment, method 600 may include determining which communication and security policies to provide to at least one application behavior analysis engine providing application security and which communication and security policies to enforce using the ADPL based on the one or more communication requirements for the application or application instance. Moreover, method 600 may include determining which communication and security policies to remove from the at least one application behavior analysis engine and which communication and security policies to stop enforcing using the ADPL based on the one or more communication requirements for the application or application instance.

The application behavior analysis engine is configured to provide application security to applications operating in the network, and may provide feedback to servers operating the applications in order to ensure malware is not operating within the network.

In one embodiment, method 600 may include registering, by the ADPL, a new application or application instance upon discovery of the new application or application instance. Furthermore, method 600 may include sending details of the new application or application instance to a policy orchestrator. The policy orchestrator is configured to retrieve a service level agreement (SLA) for a group of applications in which the application or application instance belongs. The policy orchestrator then compares the SLA to details of the spawned application or application instance.

The method 600 may also include receiving, by the ADPL from the policy orchestrator, feedback pursuant to a SLA for an application group to which the new application or application instance belongs. In response to a failed license status being indicated by the feedback, operation of the new application or application instance is ceased or otherwise caused to be stopped by the ADPL

The feedback, in one approach, includes scalability parameters for the new application or application instance which indicate an allowable number of instances for a particular application.

Moreover, method 600 may include allowing the new application or application instance to scale, by the ADPL, to an allowed number of instances based on the scalability parameters in response to a passed license status (indicates that the license is valid).

The details of the new application or application instance include, but are not limited to, application name, application directory path on a target server, a hash value (such as MD5 sum) of an executable file of the new application or application instance, a license key issued by the ADPL, a vendor name of the new application or application instance, an application user ID1, ID2, etc.

Method 600 may be implemented as a system, process, or a computer program product. As a system, method 600 may be implemented on the first host and/or the second host as logic configured to perform method 600, along with being implemented on any other hosts on which secure communications are desired. As a computer program product, a computer readable storage medium may store program instructions configured to perform method 600.

For example, a system may include a processing circuit and logic integrated with and/or executable by the processing circuit. The processing circuit is a non-transitory hardware device configured to execute logic embedded therein, or provided thereto. Examples of processing circuits include, but are not limited to, CPUs, ASICs, FPGAs, microprocessors, integrated circuits, etc. The logic is configured to cause the processing circuit to perform method 600, in one embodiment.

In another example, a computer program product may include a computer readable storage medium having program instructions stored thereon. The computer readable storage medium is a non-transitory device configured to store program instructions that are executable and/or readable by a processing circuit. The program instructions are executable by a processing circuit to cause the processing circuit to perform method 600 in one embodiment.

Variations of the systems, methods, and computer program products described herein are also possible, and the explicit description thereof in this document is not required in order to provide those of skill in the art with the ability to conceive of such variations when reading the present descriptions.

What is claimed is:

1. A system, comprising:
a processing circuit and logic integrated with and/or executable by the processing circuit, the logic being configured to cause the processing circuit to:
determine one or more communication requirements for an application or application instance operating on a server in a network using an application and data protection layer (ADPL); and
provide, by the ADPL, one or more communication and security policies to at least one security appliance in the network based on the one or more communication requirements of the application or application instance.

2. The system as recited in claim 1, wherein the one or more communication and security policies are provided to the at least one security appliance via one or more application programming interfaces (APIs), and wherein the at least one security appliance is selected from a group comprising a firewall, an intrusion detection system (IDS), and an intrusion protection system (IDS).

3. The system as recited in claim 1, wherein the one or more communication requirements are determined via one or more application programming interfaces (APIs), and wherein the logic further causes the processing circuit to:
determine which communication and security policies to provide to the at least one security appliance and which communication and security policies to enforce using the ADPL based on the one or more communication requirements for the application or application instance; and
determine which communication and security policies to remove from the at least one security appliance and which communication and security policies to stop enforcing using the ADPL based on the one or more communication requirements for the application or application instance.

4. The system as recited in claim 1, wherein the one or more communication and security policies dictate actions to be taken based on security profiles received by the ADPL.

5. The system as recited in claim 1, wherein the one or more communication requirements are determined via one or more application programming interfaces (APIs), and wherein the logic further causes the processing circuit to:
determine which communication and security policies to provide to at least one application behavior analysis engine providing application security and which communication and security policies to enforce using the ADPL based on the one or more communication requirements for the application or application instance; and
determine which communication and security policies to remove from the at least one application behavior analysis engine and which communication and security policies to stop enforcing using the ADPL based on the one or more communication requirements for the application or application instance.

6. The system as recited in claim 1, wherein the logic further causes the processing circuit to:
register, by the ADPL, a new application or application instance;
send details of the new application or application instance to a policy orchestrator;
receive, by the ADPL from the policy orchestrator, feedback pursuant to a service level agreement for an application group to which the new application or application instance belongs; and
cease operation of the new application or application instance by the ADPL in response to a failed license status,
wherein the feedback includes scalability parameters for the new application or application instance.

7. The system as recited in claim 6, wherein the logic further causes the processing circuit to:
scale, by the ADPL, the new application or application instance to an allowed number of instances based on the scalability parameters in response to a passed license status.

8. The system as recited in claim 6, wherein the details of the new application or application instance include:
application name;
application directory path on a target server;
a hash value of an executable file of the new application or application instance;
a license key issued by the ADPL; and
a vendor name of the new application or application instance.

9. A method, comprising:
determining one or more communication requirements for an application or application instance operating on a server in a network using an application and data protection layer (ADPL); and
providing, by the ADPL, one or more communication and security policies to at least one security appliance in the network based on the one or more communication requirements of the application or application instance.

10. The method as recited in claim 9, wherein the one or more communication and security policies are provided to the at least one security appliance via one or more application programming interfaces (APIs), and wherein the at least one security appliance is selected from a group comprising a firewall, an intrusion detection system (IDS), and an intrusion protection system (IDS).

11. The method as recited in claim 9, wherein the one or more communication requirements are determined via one or more application programming interfaces (APIs), and wherein the method further comprises:
determining which communication and security policies to provide to the at least one security appliance and which communication and security policies to enforce using the ADPL based on the one or more communication requirements for the application or application instance; and
determining which communication and security policies to remove from the at least one security appliance and which communication and security policies to stop enforcing using the ADPL based on the one or more communication requirements for the application or application instance.

12. The method as recited in claim 9, wherein the one or more communication and security policies dictate actions to be taken based on security profiles received by the ADPL.

13. The method as recited in claim 9, wherein the one or more communication requirements are determined via one or more application programming interfaces (APIs), and wherein the method further comprises:
determining which communication and security policies to provide to at least one application behavior analysis engine providing application security and which communication and security policies to enforce using the ADPL based on the one or more communication requirements for the application or application instance; and
determining which communication and security policies to remove from the at least one application behavior analysis engine and which communication and security policies to stop enforcing using the ADPL based on the one or more communication requirements for the application or application instance.

14. The method as recited in claim 9, further comprising:
registering, by the ADPL, a new application or application instance;
sending details of the new application or application instance to a policy orchestrator;
receiving, by the ADPL from the policy orchestrator, feedback pursuant to a service level agreement for an application group to which the new application or application instance belongs;
ceasing operation of the new application or application instance by the ADPL in response to a failed license status; and
scaling, by the ADPL, the new application or application instance to an allowed number of instances based on scalability parameters included in the feedback in response to a passed license status.

15. The method as recited in claim 14, wherein the details of the new application or application instance include:
application name;
application directory path on a target server;
a hash value of an executable file of the new application or application instance;
a license key issued by the ADPL; and
a vendor name of the new application or application instance.

16. A computer program product, comprising a computer readable storage medium having program instructions stored thereon, the program instructions being executable by a processing circuit to cause the processing circuit to:
determine one or more communication requirements for an application or application instance operating on a server in a network using an application and data protection layer (ADPL); and
provide, by the ADPL, one or more communication and security policies to at least one security appliance in the network based on the one or more communication requirements of the application or application instance.

17. The computer program product as recited in claim 16, wherein the one or more communication and security policies are provided to the at least one security appliance via one or more application programming interfaces (APIs), and wherein the at least one security appliance is selected from a group comprising a firewall, an intrusion detection system (IDS), and an intrusion protection system (IDS).

18. The computer program product as recited in claim 16, wherein the one or more communication requirements are determined via one or more application programming interfaces (APIs), and wherein the program instructions further cause the processing circuit to:
determine which communication and security policies to provide to the at least one security appliance and which communication and security policies to enforce using the ADPL based on the one or more communication requirements for the application or application instance; and
determine which communication and security policies to remove from the at least one security appliance and which communication and security policies to stop enforcing using the ADPL based on the one or more communication requirements for the application or application instance.

19. The computer program product as recited in claim 16, wherein the one or more communication requirements are determined via one or more application programming interfaces (APIs), and wherein the program instructions further cause the processing circuit to:
determine which communication and security policies to provide to at least one application behavior analysis engine providing application security and which communication and security policies to enforce using the ADPL based on the one or more communication requirements for the application or application instance; and
determine which communication and security policies to remove from the at least one application behavior analysis engine and which communication and security policies to stop enforcing using the ADPL based on the one or more communication requirements for the application or application instance.

20. The computer program product as recited in claim 16, wherein the program instructions further cause the processing circuit to:
register, by the ADPL, a new application or application instance;
send details of the new application or application instance to a policy orchestrator;
receive, by the ADPL from the policy orchestrator, feedback pursuant to a service level agreement for an application group to which the new application or application instance belongs;
cease operation of the new application or application instance by the ADPL in response to a failed license status; and
scale, by the ADPL, the new application or application instance to an allowed number of instances based on scalability parameters included in the feedback.
